(19) United States
(12) Patent Application Publication
(10) Pub. No.: US 2026/0312344 A1
(43) Pub. Date: Oct. 8, 2026

(54) NETWORK SOCKET AND NETWORK SYSTEM

(71) Applicant: TELEBOX INDUSTRIES CORP., Hsichih-Taipei (TW)

(72) Inventors: Hsiu Hau CHANG, Taipei City (TW); Ching-Yi HSU, Keelung City (TW); Yu-Wen CHO, Taipei City (TW)

(73) Assignee: TELEBOX INDUSTRIES CORP., Hsichih-Taipei (TW)

(21) Appl. No.: 19/240,554

(22) Filed: Jun. 17, 2025

(30) Foreign Application Priority Data
Apr. 7, 2025 (TW) 114112990

(51) Int. Cl. H01R 13/717

(52) U.S. Cl. CPC H01R 13/7175; H01R 13/7172

(57) ABSTRACT

A network socket includes a housing, a terminal assembly and a light-emitting module. The housing has a first insertion hole and an accommodation space communicating with each other. The terminal assembly is disposed in the accommodation space. The terminal assembly includes a first circuit board and a plurality of first conductive terminals, each of the first conductive terminals has a first end and a second end located opposite to each other, the first ends of the first conductive terminals are electrically connected to the first circuit board. The light-emitting module is disposed in the accommodation space. The light-emitting module includes a second circuit board and at least one light-emitting component, the light-emitting component is electrically connected to the second circuit board, the second ends of at least a portion of the first conductive terminals are detachably and electrically connected to the second circuit board.

### CROSS-REFERENCE TO RELATED APPLICATIONS

This non-provisional application claims priority under 35 U.S.C. § 119(a) on Patent Application No(s). 114112990 filed in Taiwan, R.O.C. on Apr. 7, 2025, the entire contents of which are hereby incorporated by reference.

### TECHNICAL FIELD

The disclosure relates to a network socket and a network system.

### BACKGROUND

Currently, during the process of plugging a network cable into a socket, users often need to insert the network cable into the socket and rely on whether signal transmission is functioning properly to determine whether the socket is powered. In other words, users are unable to know whether the socket is powered before inserting the network cable, which means they can only test the socket's power status by actually inserting the network cable. As a result, it is difficult to quickly determine whether the socket is powered. Therefore, how to address the aforementioned issue is one of the topics in this field.

### SUMMARY

The disclosure provides a network socket and a network system that enable users to quickly determine whether the socket is powered before plugging the network cable.

One embodiment of the disclosure provides a network socket. The network socket is configured to receive a plug. The network socket includes a housing, a terminal assembly and a light-emitting module. The housing has a first insertion hole and an accommodation space, and the first insertion hole communicates with the accommodation space. The terminal assembly is disposed in the accommodation space. The terminal assembly includes a first circuit board and a plurality of first conductive terminals, each of the plurality of first conductive terminals has a first end and a second end located opposite to each other, the first ends of the plurality of first conductive terminals are fixed and electrically connected to the first circuit board, the plurality of first conductive terminals are configured to be electrically connected to the plug inserted into the accommodation space through the first insertion hole. The light-emitting module is disposed in the accommodation space. The light-emitting module includes a second circuit board and at least one light-emitting component, the at least one light-emitting component is disposed on and electrically connected to the second circuit board, the second ends of at least a portion of the plurality of first conductive terminals are detachably and electrically connected to the second circuit board.

Another embodiment of the disclosure provides a network system. The network system includes a network device and the aforementioned network socket. The network socket is electrically connected to the network device for receiving a first voltage or a second voltage, greater than or equal to the first voltage, output from the network device. When the plug is not inserted into the network socket, the at least one light-emitting component of the network socket is driven to emit light by the first voltage output from the network device. When the plug is inserted into the network socket, the terminal assembly of the network socket receives the second voltage output from the network device, and the at least one light-emitting component is separated from the terminal assembly.

According to the network socket and the network system as discussed in the above embodiments, the light-emitting module is disposed in the accommodation space, the light-emitting components of the light-emitting module are disposed and electrically connected to the second circuit board, and the second ends of at least a portion of the first conductive terminals of the terminal assembly are detachably electrically connected to the second circuit board. By the aforementioned configuration, the user can quickly determine whether the network socket is powered or whether a power source is supplying power to the network socket by observing whether the light-emitting components are lit prior to plugging the network cable into the network socket.

### BRIEF DESCRIPTION OF THE DRAWINGS

The present disclosure will become better understood from the detailed description given herein below and the accompanying drawings which are given by way of illustration only and thus are not intending to limit the present disclosure and wherein:

FIG. 1 is a perspective view of a network socket and a cable according to a first embodiment of the disclosure;

FIG. 2 is an exploded view of the network socket and the cable in FIG. 1;

FIG. 3 is a cross-sectional view of the network socket and the cable in FIG. 1;

FIG. 4 is a schematic view of a light-emitting module in FIG. 2;

FIG. 5 is a cross-sectional view of the network socket in FIG. 3 when assembled with a network cable;

FIG. 6 is a perspective view of a network socket according to a second embodiment of the disclosure;

FIG. 7 is an exploded view of the network socket in FIG. 6;

FIG. 8 is a cross-sectional view of the network socket in FIG. 6;

FIG. 9 is a cross-sectional view of the network socket in FIG. 8 when assembled with a network cable;

FIG. 10 is a perspective view of a network socket according to a third embodiment of the disclosure;

FIG. 11 is an exploded view of the network socket in FIG. 10;

FIG. 12 is a cross-sectional view of the network socket in FIG. 10;

FIG. 13 is a perspective view of a network socket according to a fourth embodiment of the disclosure;

FIG. 14 is an exploded view of the network socket in FIG. 13; and

FIG. 15 is a cross-sectional view of the network socket in FIG. 13.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In addition, the terms used in the present disclosure, such as technical and scientific terms, have its own meanings and can be comprehended by those skilled in the art, unless the terms are additionally defined in the present disclosure. That is, the terms used in the following paragraphs should be read on the meaning commonly used in the related fields and will not be overly explained, unless the terms have a specific meaning in the present disclosure.

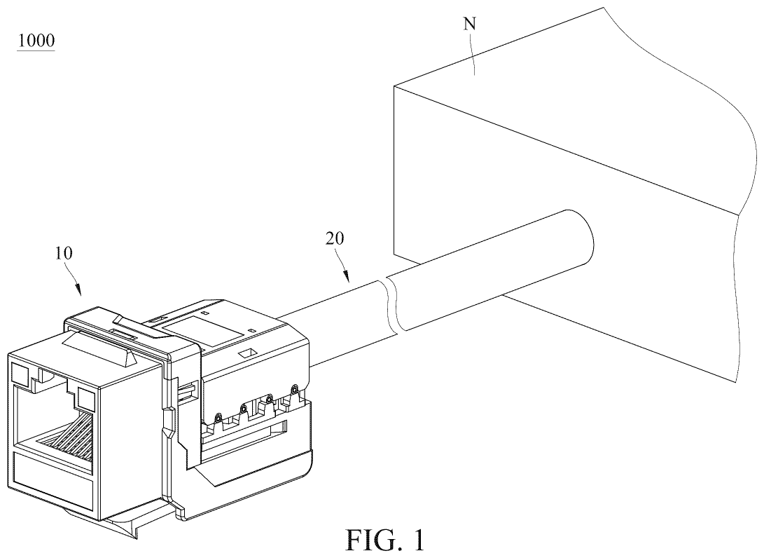

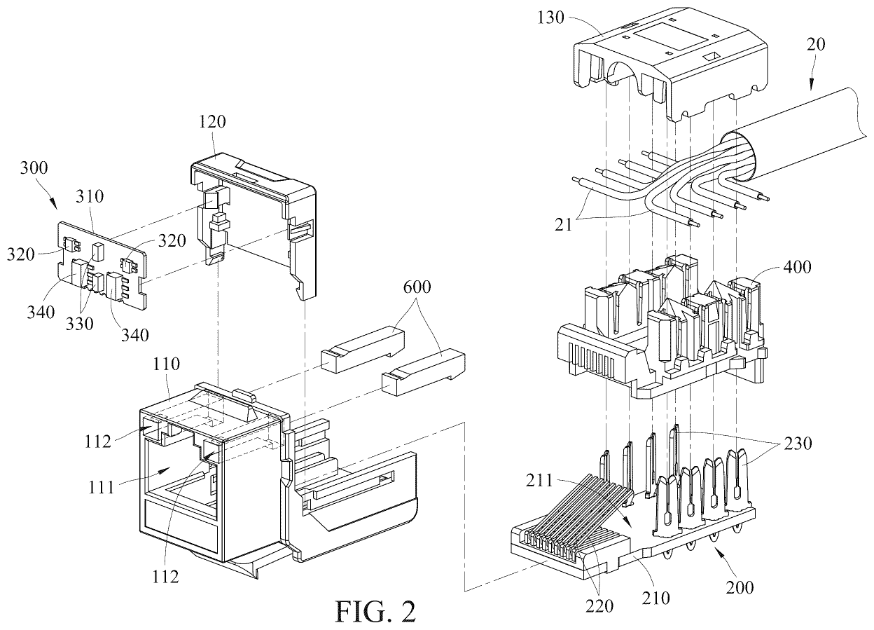

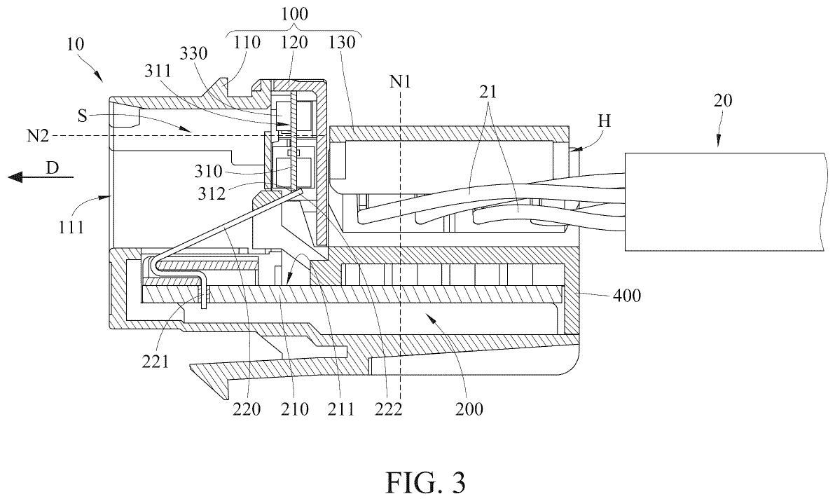

Referring to FIGS. 1 to 3, FIG. 1 is a perspective view of a network socket and a cable according to a first embodiment of the disclosure, FIG. 2 is an exploded view of the network socket and the cable in FIG. 1, and FIG. 3 is a cross-sectional view of the network socket and the cable in FIG. 1.

In this embodiment, the network socket 10 is configured to be connected to a network device N via a cable 20, where the network socket 10, the cable 20, and the network device N together form a network system 1000. The network socket 10 is a Power over Ethernet (PoE) socket. The network socket 10 includes a housing 100, a terminal assembly 200, and a light-emitting module 300.

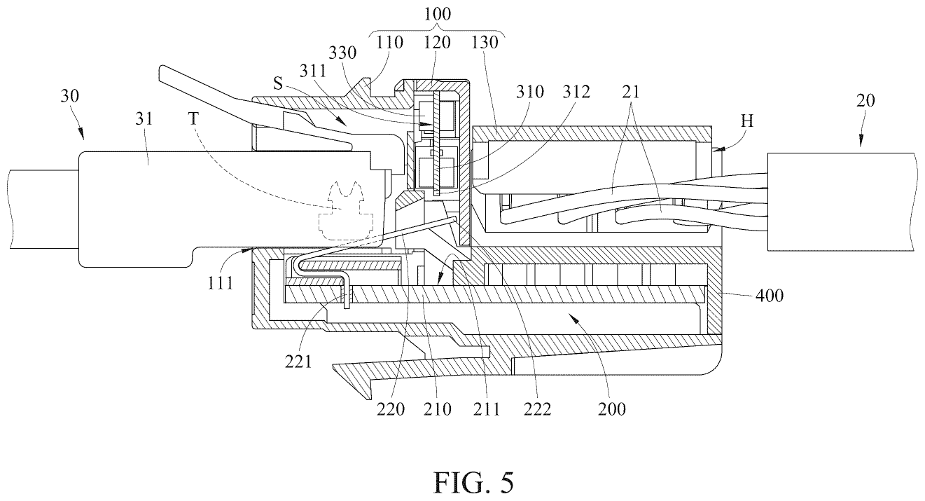

The housing 100, for example, includes a base portion 110, a support portion 120, and a cover portion 130. The support portion 120 and the cover portion 130 are assembled to the base portion 110, and the base portion 110, support portion 120, and cover portion 130 together form an accommodating space S. The base portion 110 has a first insertion hole 111, which is located at one side of the accommodating space S and communicates with the accommodating space S. The first insertion hole 111 is configured to allow a plug 31 of a network cable 30 (see FIG. 5) to pass therethrough, thereby enabling the plug 31 of the network cable 30 to enter the accommodating space S.

The terminal assembly 200 is disposed in the accommodating space S and is supported by the base portion 110. The terminal assembly 200 includes a first circuit board 210 and a plurality of first conductive terminals 220. The first circuit board 210 has a first support surface 211, and a normal line N1 of the first support surface 211 is, for example, perpendicular to an opening direction D of the first insertion hole 111. Each of the first conductive terminals 220 has a first end 221 and a second end 222 located opposite to each other. The first ends 221 of the first conductive terminals 220 are fixed and electrically connected to the first support surface 211 of the first circuit board 210. The first conductive terminals 220 are, for example, arranged in a direction from one side to another side of the first insertion hole 111. For instance, the quantity of the first conductive terminals 220 is eight, and they are numbered from 1 to 8 in sequence from one side to another side of the first insertion hole 111 (e.g., from the right side to the left side of the first insertion hole 111). These first conductive terminals 220 are configured to be electrically connected to the plug 31 of the network cable 30.

In this embodiment, the network socket 10 may further include a wire management holder 400, and the terminal assembly 200 may further include a plurality of insulation displacement connectors 230. The wire management holder 400 is configured to be assembled with a plurality of core wires 21 of the cable 20. The wire management holder 400 is disposed in the accommodating space S and, and the wire management holder 400 and the cover portion 130 together form a cable mounting hole H. The cable mounting hole H communicates with the accommodating space S and is located opposite to the first insertion hole 111. The cable mounting hole H is configured to receive the cable 20. The insulation displacement connectors 230 are disposed on the first circuit board 210 and are assembled with the wire management holder 400 for respectively piercing the core wires 21.

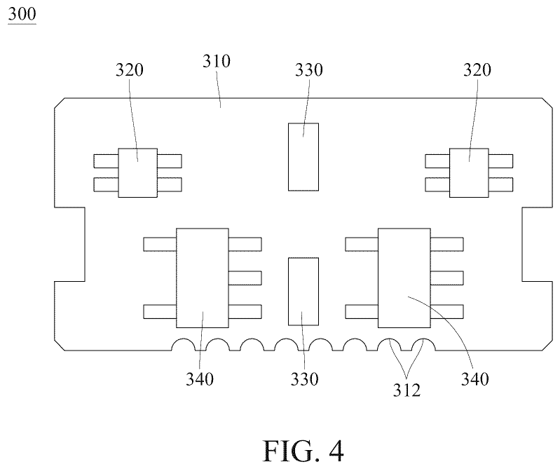

Then, referring to FIGS. 3 and 4, FIG. 4 is a schematic view of a light-emitting module in FIG. 2.

The light-emitting module 300 is disposed in the accommodating space S and is supported by the support portion 120. The light-emitting module 300 includes a second circuit board 310 and two light-emitting components 320. The second circuit board 310 has a second support surface 311, and a normal line N2 of the second support surface 311 is parallel to the opening direction D of the first insertion hole 111. The two light-emitting components 320 are, for example, disposed on two opposite sides (e.g., the left and right sides) of the second support surface 311 of the second circuit board 310, and the light-emitting components 320 are electrically connected to the second circuit board 310.

The second circuit board 310 has a plurality of conductive portions 312, which are arranged in a direction from one side to another side of the first insertion hole 111 (e.g., from the right side to the left side of the first insertion hole 111). The second ends 222 of the first conductive terminals 220 are respectively and detachably electrically connected to the conductive portions 312 of the second circuit board 310.

For example, one of the light-emitting components 320 is electrically connected to a portion of the first conductive terminals 220, while the other light-emitting component 320 is electrically connected to another portion of the first conductive terminals 220. More specifically, two electrodes of the right-side light-emitting component 320 are respectively electrically connected, via corresponding conductive portions 312, to one of the first conductive terminals 220 numbered either 1 or 2, and to one of the first conductive terminals 220 numbered either 3 or 6. Two electrodes of the left-side light-emitting component 320 are respectively electrically connected, via corresponding conductive portions 312, to one of the first conductive terminals 220 numbered either 4 or 5, and to one of the first conductive terminals 220 numbered either 7 or 8.

In this embodiment, as shown in FIG. 2, the base portion 110 of the housing 100 may further have two light-transmitting holes 112. The two light-transmitting holes 112 are located aside the first insertion hole 111 and respectively correspond to the two light-emitting components 320. The network socket 10 may further include two light-guiding components 600, which are respectively disposed in the two light-transmitting holes 112 to guide light emitted by the two light-emitting components 320.

It should be noted that the light-guiding components 600 and the light-transmitting holes 112 are optional components and structures, and may be omitted in other embodiments.

In this embodiment, when no network cable 30 is plugged into the network socket 10, the network device N may provide a detection voltage (e.g., a first voltage ranging from about 2.7 V to 10.1 V) to the network socket 10 via the cable 20 to detect whether a network cable 30 is inserted into the network socket 10. When the detection voltage is applied to the light-emitting components 320, the light-emitting components 320 emit light and blink. At this time, a user can know that the network socket 10 is powered and its power status through the lighting and blinking of the light-emitting components 320. The power status may be, for example, PoE Type 1 (802.3af), Type 2 (802.3at), Type 3 (802.3bt), or Type 4 (802.3bt). Furthermore, the light-emitting components 320 have a plurality of power statuses to present various visual effects. For example, the detection voltage can be applied in either a forward or reverse manner to the two light-emitting components 320. When the voltage is applied forward to the light-emitting components 320 (e.g., the first conductive terminal 220 numbered 1 or 2 and the first conductive terminal 220 numbered 3 or 6 are electrically connected to the positive and negative electrodes of one of the light-emitting components 320, respectively, and the first conductive terminal 220 numbered 4 or 5 and the first conductive terminal 220 numbered 7 or 8 are electrically connected to the positive and negative electrodes of the other light-emitting component 320, respectively), the light-emitting components 320 emit green light and blink. When the voltage is applied in reverse to the light-emitting components 320 (e.g., the first conductive terminal 220 numbered 1 or 2 and the first conductive terminal 220 numbered 3 or 6 are electrically connected to the negative and positive electrodes of one of the light-emitting components 320, respectively, and the first conductive terminal 220 numbered 4 or 5 and the first conductive terminal 220 numbered 7 or 8 are electrically connected to the negative and positive electrodes of the other light-emitting component 320, respectively), the light-emitting components 320 emit orange light and blink. When only one light-emitting component 320 lights up, the network socket 10 is in PoE Mode A or PoE Mode B. When both light-emitting components 320 light up, the network socket 10 is in PoE++ four-pair mode.

Accordingly, the light-emitting module 300 is disposed in the accommodation space S, the light-emitting components 320 of the light-emitting module 300 are disposed and electrically connected to the second circuit board 310, and the second ends 222 of the first conductive terminals 220 of the terminal assembly 200 are detachably electrically connected to the second circuit board 310. By the aforementioned configuration, the user can quickly determine whether the network socket 10 is powered or whether a power source is supplying power to the network socket 10 by observing whether the light-emitting components 320 are lit prior to plugging the network cable 30 into the network socket 10.

Once the user observes that the light-emitting components 320 are lit, the user can determine that the network socket 10 is powered and can directly insert the plug 31 of the network cable 30 into the network socket 10. Please refer to FIG. 5, FIG. 5 is a cross-sectional view of the network socket in FIG. 3 when assembled with a network cable. When the plug 31 of the network cable 30 is inserted into the accommodation space S through the first insertion hole 111, the plug 31 of the network cable 30 forces the second ends 222 of the first conductive terminals 220 to separate from the conductive portions 312 of the second circuit board 310, and terminals T inside the plug 31 of the network cable 30 come into electrical contact with the first conductive terminals 220. As a result, the second circuit board 310 is no longer electrically connected to the first conductive terminals 220, and the detection voltage can no longer be transmitted to the light-emitting components 320, causing the light-emitting components 320 to turn off. Conversely, the detection voltage is now transmitted through the first conductive terminals 220 to the network cable 30, allowing the network device N to detect that the network cable 30 has been plugged into the network socket 10. The network device N may then increase the voltage (e.g., to a second voltage greater than the first voltage) to supply the high voltage (e.g., 48V) to the electronic device connected to the network cable 30, or alternatively, the network device N may supply the same voltage (e.g., the second voltage being equal to the first voltage) to the electronic device connected to the network cable 30.

In this embodiment, by configuring the second ends 222 of the first conductive terminals 220 of the terminal assembly 200 to be detachably and electrically connected to the second circuit board 310, the high voltage supplied by the network device N can be prevented from being transmitted to the light-emitting components 320 after the network cable 30 is inserted into the network socket 10, thereby protecting the light-emitting components 320.

It should be noted that the normal line N1 of the first circuit board 210 is perpendicular to the opening direction D. In other embodiments, the normal line of the first circuit board may be parallel to the opening direction. In other words, the first circuit board and the second circuit board may be arranged in parallel.

Furthermore, in this embodiment, the first circuit board 210 and the second circuit board 310 are two separate circuit boards, but are not limited thereto. In other embodiments, the first circuit board and the second circuit board may be integrated into a single circuit board.

In this embodiment, the light-emitting module 300 may further include a plurality of protection components 330 and 340. The protection components 330 and 340 may be, for example, a capacitor and a resistor, respectively. These protection components 330 and 340 are disposed on the second circuit board 310. In other words, the protection components 330 and 340 are mounted on the second circuit board 310, which passively receives the voltage applied by the network device N, so as to further prevent the light-emitting components 320 from being damaged by the high voltage. It should be noted that the protection components 330 and 340 are optional components and may be omitted.

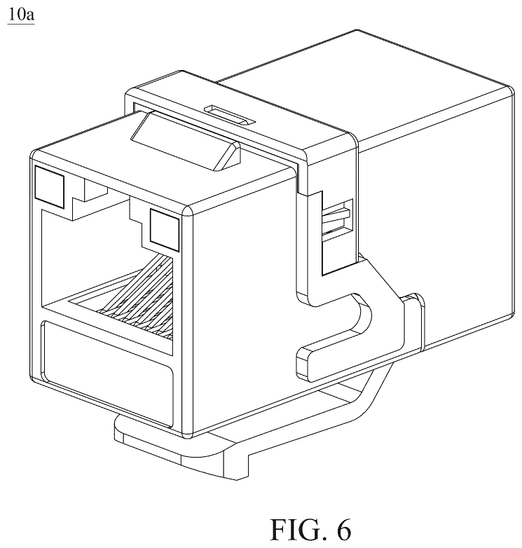

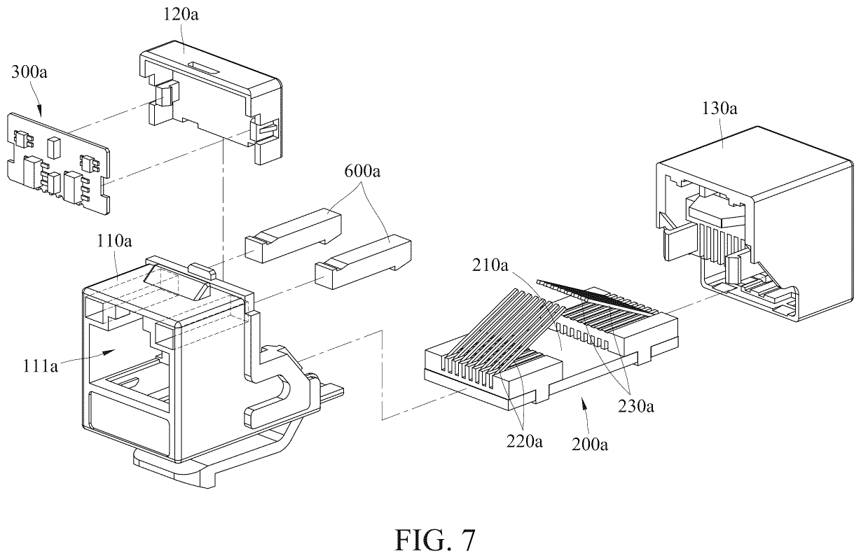

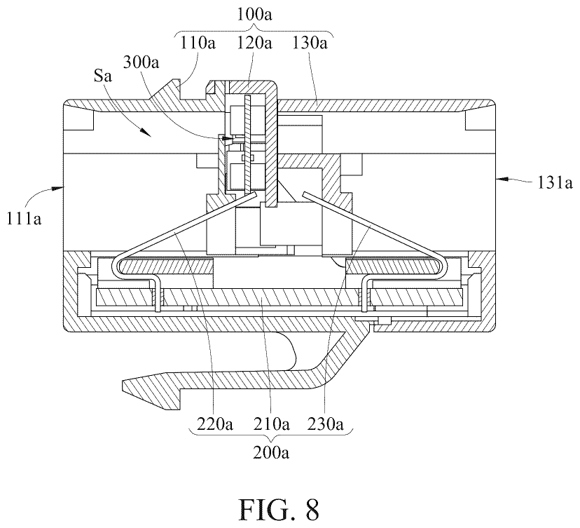

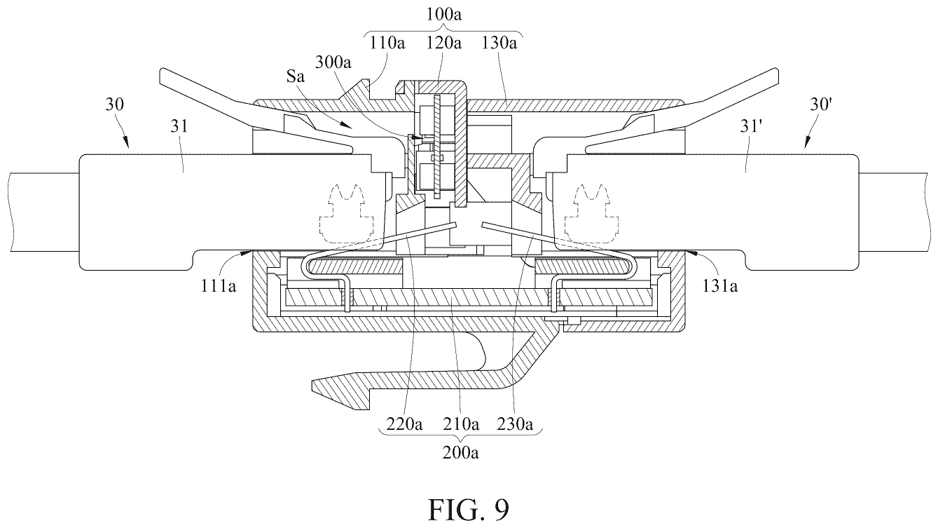

Referring to FIGS. 6 to 9, FIG. 6 is a perspective view of a network socket according to a second embodiment of the disclosure, FIG. 7 is an exploded view of the network socket in FIG. 6, FIG. 8 is a cross-sectional view of the network socket in FIG. 6, and FIG. 9 is a cross-sectional view of the network socket in FIG. 8 when assembled with a network cable.

A network socket 10a of this embodiment is similar to the network socket 10 of the previous embodiment. The following will mainly describe the differences between them, while the same parts may be referred to the paragraphs of the previous embodiment and will not be repeatedly described hereinafter.

In this embodiment, the network socket 10a is configured to couple two network cables 30 and 30′. The network socket 10a includes a housing 100a, a terminal assembly 200a, a light-emitting module 300a, and two light-guiding components 600a, but does not include a wire management holder, and the terminal assembly 200a also does not include any insulation displacement connectors.

The housing 100a includes a first housing portion 110a, a second housing portion 130a, and a support portion 120a. The first housing portion 110a, the second housing portion 130a, and the support portion 120a together form an accommodation space Sa. The first housing portion 110a has a first insertion hole 111a, and the second housing portion 130a has a second insertion hole 131a. The first insertion hole 111a and the second insertion hole 131a are located at two opposite sides of the accommodation space Sa and communicate with the accommodation space Sa. The first insertion hole 111a allows a plug 31 of the network cable 30 to pass through and enter the accommodation space Sa, while the second insertion hole 131a allows a plug 31′ of the network cable 30′ to pass through and enter the accommodation space Sa.

In addition to including a first circuit board 210a and a plurality of first conductive terminals 220a, the terminal assembly 200a further includes a plurality of second conductive terminals 230a. The first conductive terminals 220a are disposed on one side of the first circuit board 210a near the first insertion hole 111a, while the second conductive terminals 230a are disposed on another side of the first circuit board 210a near the second insertion hole 131a. The first conductive terminals 220a are configured to be electrically connected to the plug 31 of the network cable 30 inserted into the accommodation space Sa through the first insertion hole 111a, and the second conductive terminals 230a are configured to be electrically connected to the plug 31′ of the network cable 30′ inserted into the accommodation space Sa through the second insertion hole 131a.

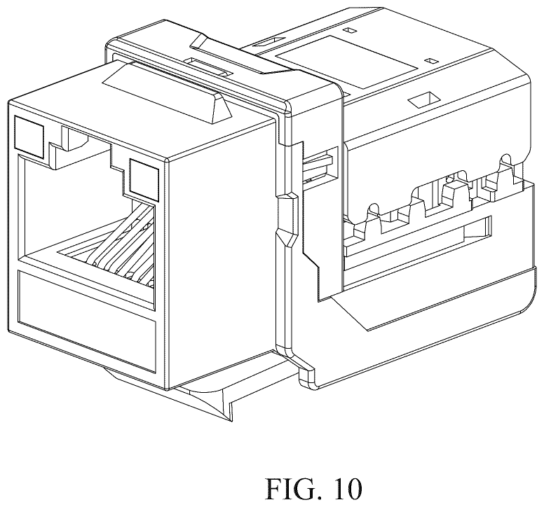

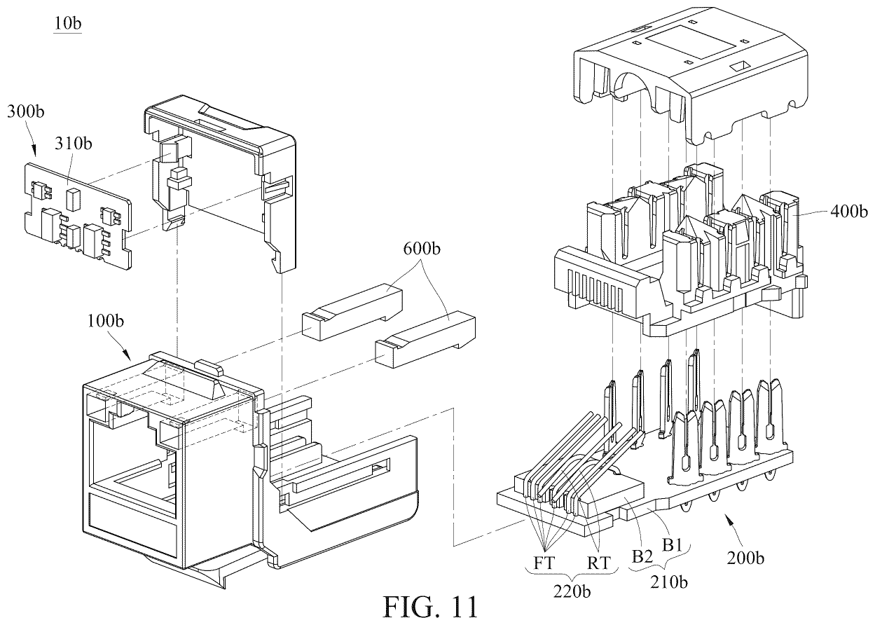

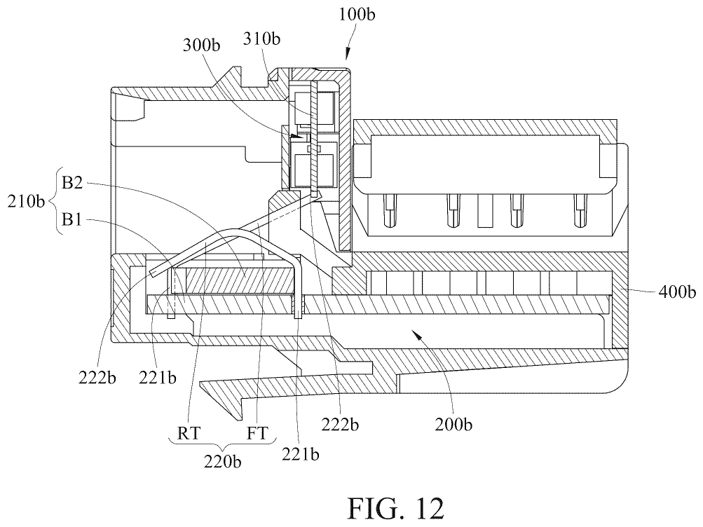

Then, referring to FIGS. 10 to 12, FIG. 10 is a perspective view of a network socket according to a third embodiment of the disclosure, FIG. 11 is an exploded view of the network socket in FIG. 10, and FIG. 12 is a cross-sectional view of the network socket in FIG. 10.

A network socket 10b of this embodiment is similar to the network socket 10 of the previous embodiment. The network socket 10b of this embodiment also includes a housing 100b, a terminal assembly 200b, a wire management holder 400b, a light-emitting module 300b, and two light-guiding components 600b. The following paragraphs mainly describe the differences between the network socket 10b of this embodiment and the network socket 10 of the previous embodiment, while the same parts may be referred to the paragraphs of the previous embodiment and will not be repeatedly described hereinafter.

In this embodiment, a first circuit board 210b of the terminal assembly 200b includes a first substrate B1 and a second substrate B2. A size of the first substrate B1 is greater than a size of the second substrate B2, and the second substrate B2 is stacked on the first substrate B1. First conductive terminals 220b of the terminal assembly 200b include a plurality of front conductive terminals FT and a plurality of rear conductive terminals RT. Each of the front conductive terminals FT has a first end 221b fixed on the first substrate B1 and located at one side of the second substrate B2. Each of the front conductive terminals FT has a second end 222b that is detachably electrically connected to a second circuit board 310b of the light-emitting module 300b. Each of the rear conductive terminals RT has a first end 221b fixed on the first substrate B1 and located at another side of the second substrate B2. Each of the rear conductive terminals RT has a second end 222b that is not electrically connected to the second circuit board 310b.

It should be noted that the aforementioned network socket is in a single-port configuration, but is not limited thereto. In other embodiments, the network socket may be in a multi-port configuration (e.g., applied to a network switch panel), with each port being provided with a terminal assembly and a light-emitting module.

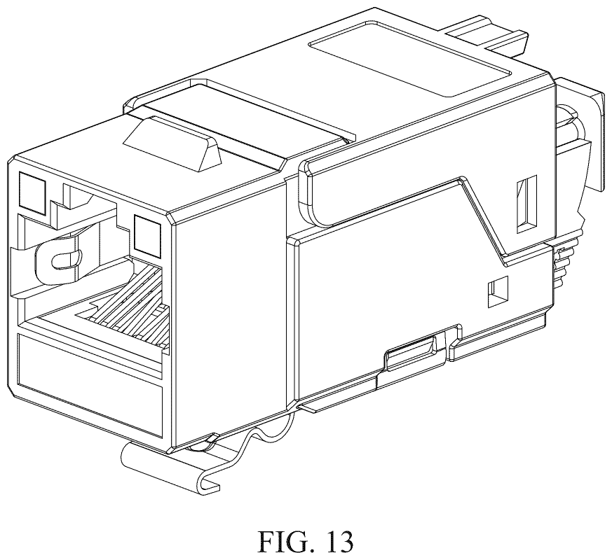

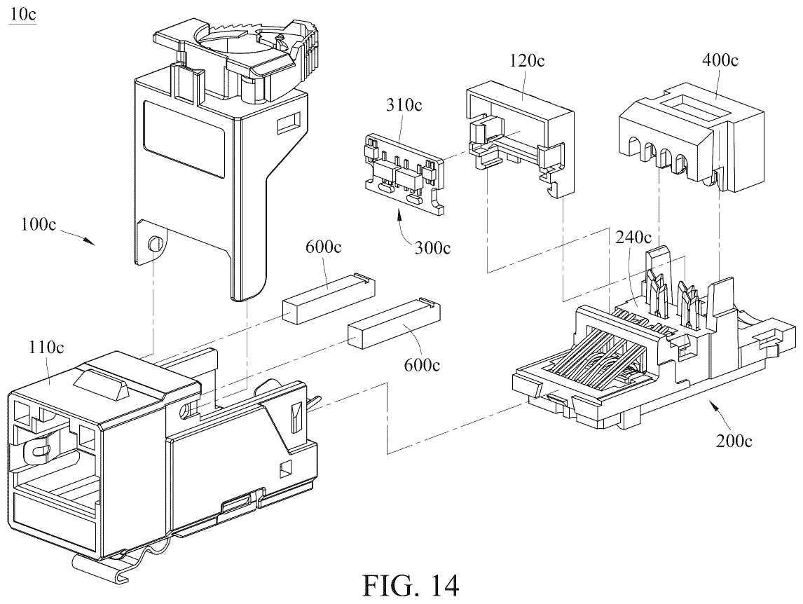

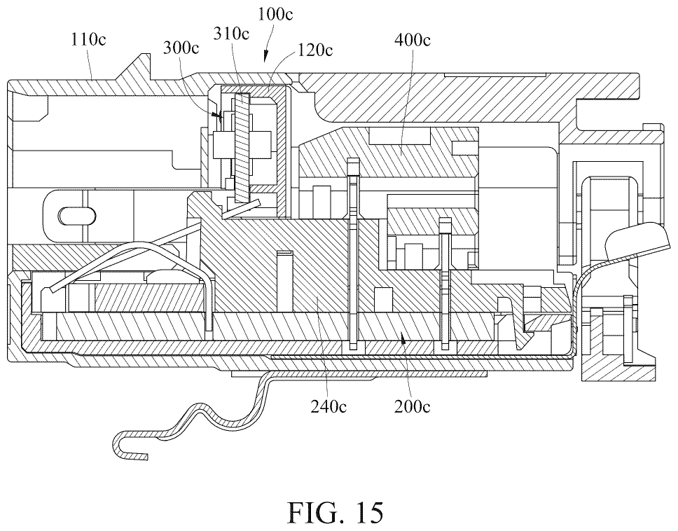

Then, referring to FIGS. 13 to 15, FIG. 13 is a perspective view of a network socket according to a fourth embodiment of the disclosure, FIG. 14 is an exploded view of the network socket in FIG. 13, and FIG. 15 is a cross-sectional view of the network socket in FIG. 13.

A network socket 10c of this embodiment is similar to the network socket 10b of the previous embodiment. The network socket 10c also includes a housing 100c, a terminal assembly 200c, a wire management holder 400c, a light-emitting module 300c, and two light-guiding components 600c. The following paragraphs mainly describe the differences between the network socket 10c of this embodiment and the network socket 10b of the previous embodiment, while the same parts may refer to the paragraphs of the previous embodiment and will not be repeatedly described hereinafter.

In this embodiment, a support portion 120c of the housing 100c, which is configured to support a second circuit board 310c of the light-emitting module 300c, is mounted on a terminal base 240c of the terminal assembly 200c and is accommodated in a base portion 110c of the housing 100c.

According to the network socket and the network system as discussed in the above embodiments, the light-emitting module is disposed in the accommodation space, the light-emitting components of the light-emitting module are disposed and electrically connected to the second circuit board, and the second ends of at least a portion of the first conductive terminals of the terminal assembly are detachably electrically connected to the second circuit board. By the aforementioned configuration, the user can quickly determine whether the network socket is powered or whether a power source is supplying power to the network socket by observing whether the light-emitting components are lit prior to plugging the network cable into the network socket.

It will be apparent to those skilled in the art that various modifications and variations can be made to the present disclosure. It is intended that the specification and examples be considered as exemplary embodiments only, with a scope of the disclosure being indicated by the following claims and their equivalents.

What is claimed is:

1. A network socket, configured to receive a plug, comprising:
a housing, having a first insertion hole and an accommodation space, wherein the first insertion hole communicates with the accommodation space;
a terminal assembly, disposed in the accommodation space, wherein the terminal assembly comprises a first circuit board and a plurality of first conductive terminals, each of the plurality of first conductive terminals has a first end and a second end located opposite to each other, the first ends of the plurality of first conductive terminals are fixed and electrically connected to the first circuit board, the plurality of first conductive terminals are configured to be electrically connected to the plug inserted into the accommodation space through the first insertion hole; and
a light-emitting module, disposed in the accommodation space, wherein the light-emitting module comprises a second circuit board and at least one light-emitting component, the at least one light-emitting component is disposed on and electrically connected to the second circuit board, the second ends of at least a portion of the plurality of first conductive terminals are detachably and electrically connected to the second circuit board.

2. The network socket according to claim 1, wherein the housing has at least one light-transmitting hole, the at least one light-transmitting hole is located aside the first insertion hole, and the at least one light-transmitting hole corresponds to the at least one light-emitting component.

3. The network socket according to claim 2, further comprising at least one light-guiding component, wherein the at least one light-guiding component is disposed in the at least one light-transmitting hole.

4. The network socket according to claim 1, wherein the at least one light-emitting component comprises two light-emitting components, one of the two light-emitting components is electrically connected to a portion of the plurality of first conductive terminals, and the other one of the two light-emitting components is electrically connected to another portion of the plurality of first conductive terminals.

5. The network socket according to claim 4, wherein the plurality of first conductive terminals are numbered from 1 to 8 in sequence from one side to another side of the first insertion hole, two electrodes of one of the two light-emitting components are electrically connected to one of the plurality of first conductive terminals numbered 1 or 2 and one of the plurality of first conductive terminals numbered 3 or 6, and two electrodes of the other one of the two light-emitting components are electrically connected to one of the plurality of first conductive terminals numbered 4 or 5 and one of the plurality of first conductive terminals numbered 7 or 8.

6. The network socket according to claim 1, wherein the first circuit board has a first support surface, a normal line of the first support surface is perpendicular to an opening direction of the first insertion hole, the first ends of the plurality of first conductive terminals are disposed on the first support surface of the first circuit board, the second circuit board has a second support surface, a normal line of the second support surface is parallel to the opening direction of the first insertion hole, and the at least one light-emitting component is disposed on the second support surface of the second circuit board.

7. The network socket according to claim 1, further comprising a wire management holder, wherein the terminal assembly further comprises a plurality of insulation displacement connectors, the housing has a cable mounting hole, the cable mounting hole communicates with the accommodation space and is located opposite to the first insertion hole, the cable mounting hole is configured to receive a cable, the wire management holder is disposed in the accommodation space, the wire management holder is configured to be assembled with a plurality of core wires of the cable, the plurality of insulation displacement connectors are disposed on the first circuit board, and the plurality of insulation displacement connector are assembled with the wire management holder for respectively piercing the plurality of core wires.

8. The network socket according to claim 1, wherein the terminal assembly further comprises a plurality of second conductive terminals, the housing further has a second insertion hole, the second insertion hole communicates with the accommodation space and is located opposite to the first insertion hole, the plurality of second conductive terminals are fixed and electrically connected to the first circuit board, the plurality of second conductive terminals are configured to be electrically connected to another plug inserted into the accommodation space through the second insertion hole.

9. The network socket according to claim 1, wherein the first circuit board comprises a first substrate and a second substrate, a size of the first substrate is greater than a size of the second substrate, the second substrate is stacked on the first substrate, the plurality of first conductive terminals comprise a plurality of front conductive terminals and a plurality of rear conductive terminals, the first ends of the plurality of front conductive terminals are fixed to the first substrate and located at one side of the second substrate, the second ends of the plurality of front conductive terminals are detachably and electrically connected to the second circuit board, the first ends of the plurality of rear conductive terminals are fixed to the first substrate and located at another side of the second substrate, and the second ends of the plurality of rear conductive terminals are not electrically connected to the second circuit board.

10. The network socket according to claim 1, wherein the second ends of all of the plurality of first conductive terminals are detachably and electrically connected to the second circuit board.

11. The network socket according to claim 1, wherein the light-emitting module further comprises a plurality of protection components, and the plurality of protection components are disposed on the second circuit board.

12. The network socket according to claim 1, wherein the at least one light-emitting component has a plurality of power statuses to present various visual effects.

13. A network system, comprising:
a network device; and
the network socket according to claim 1, electrically connected to the network device for receiving a first voltage or a second voltage, greater than or equal to the first voltage, output from the network device;
wherein, when the plug is not inserted into the network socket, the at least one light-emitting component of the network socket is driven to emit light by the first voltage output from the network device;
wherein, when the plug is inserted into the network socket, the terminal assembly of the network socket receives the second voltage output from the network device, and the at least one light-emitting component is separated from the terminal assembly.
